(19) United States
(12) Patent Application Publication
(10) Pub. No.: US 2008/0135569 A1
(43) Pub. Date: Jun. 12, 2008

(54) Diagnostic test strip counter

(76) Inventors: Harold Chan, San Marcos, CA (US); Leslie Rehg, Poway, CA (US); Joseph Nolan, San Diego, CA (US)

Correspondence Address: GENZYME CORPORATION;LEGAL DEPARTMENT, 15 PLEASANT ST CONNECTOR, FRAMINGHAM, MA, 01701-9322, US

(21) Appl. No.: 11/637,391

(22) Filed: Dec. 12, 2006

(51) Int. Cl. B65G 47/04

(52) U.S. Cl. 221/1; 221/2

(57) ABSTRACT

The invention provides a counting apparatus for providing a predetermined number of diagnostic test strips, the counting apparatus including a tray having a plurality of elongate indentations, each of which is configured to receive at least one diagnostic test strip, wherein at least one of the elongate indentations is open along one end proximate to an edge of the tray, and a funnel for receiving and directing a predetermined quantity of test strips from at least one open indentation on the tray. The invention further provides a method for using a counting apparatus to provide an accurate count of a predetermined number of diagnostic test strips for packaging.

### BACKGROUND OF THE INVENTION

1. Field of the Invention

The present invention relates to a counting apparatus for counting diagnostic test strips. Particularly, the present invention is directed to a counting apparatus for providing a predetermined number of diagnostic test strips for packaging.

2. Description of the Related Art

Many medical, chemical and biological diagnostic tests and assays for laboratory and home use have been reduced to an optimally simple routine: immerse a diagnostic test strip or dip stick (hereinafter, “test strip”) into a liquid, and observe the change in color of the test strip to ascertain the results of the test or assay. Tests that formerly required days of laboratory work may now be carried out much more quickly, with a reliability factor that exceeds former, more time-consuming methods.

Generally speaking, the test strips comprise long, narrow pieces of paper, plastic, laminates, or other suitable thin sheet material treated with one or more highly specific reagents, reactants, or assay compounds that can exhibit a color change when exposed to a particular substance. In medical procedures, for example, certain substances in biological fluids such as urine or blood are indicative of particular medical conditions. For example, test strips sensitive to glucose and acetone are used in the diagnosis and monitoring of diabetes patients. Test strips sensitive to certain hormones are used to detect pregnancy. Test strips having other compositions may detect a variety of other physiological conditions. Such strips may also be used for non-medical purposes such as detecting the presence of a particular chemical composition in a fluid.

The test strips are customarily packaged in containers such as bottles, vials, pouches, or other suitable packaging after manufacture. It is desirable that each container used ends up containing a known predetermined number of test strips. Accuracy in counting test strips for packaging is therefore desirable. Without an accurate means of counting, suppliers must err on the side of over counting because undercounting leads to failure to conform to statements of quantity on package labeling. However, over counting adds to the costs of suppliers.

A variety of devices and methods are known in the art for counting diagnostic test strips. Of such devices, many are directed to automated counting, while others involve manual methods.

One method of counting test strips for packaging is to manually count the test strips prior to packaging to ensure the proper number of test strips is included in each package. This method is difficult because the fragile nature of the test strips makes them prone to breaking when manipulated. This breakage constitutes a costly waste. Further, manual counting of the fragile test strips is undesirable because of the intensive labor and time involved. Manual counting is also undesirable because of the human error involved, which cannot verifiably ensure accuracy.

Another method for counting test strips involves weighing batches of test strips. A predetermined number of test strips to be packaged can be multiplied by the weight per test strip to determine the weight per batch. Then a scale or other weight-measuring device is used to measure out the proper weight of a batch of test strips for each package. However, this method of counting is also less than perfect. Test strips can vary in weight by a factor of up to 20% and thus weight measurement cannot be relied upon as an exact determination of number of test strips. In order to comply with labeling requirements, packagers using the weighing method of counting must over count the test strips to comply with labeling requirements, resulting in added cost to the supplier, as discussed above.

It is also known in the art to use automated processes to count and package test strips. Automated counting and packaging processes can be fairly efficient and accurate. Nonetheless, automated counting of test strips for packaging is difficult to do accurately because of the nature and properties of the test strips. Due to the low ratio of mass to surface area of individual test strips, the test strips can be extremely difficult to manipulate (grasp, translate, apply, etc.) individually. In addition, the materials from which the test strips are formed (such as paper stock, thin plastic web, etc.) may easily accumulate static electricity charges. The effect of static electricity on the low mass, high surface area test strips may exceed the gravitational force that could otherwise benefit automation. Likewise, stray air currents can disrupt even well designed handling machinery. Finally, the elastic properties of test strips can cause them to fall erratically onto machine surfaces, causing alignment and stacking problems. Since automated processes for the counting and packaging of test strips must overcome these complications, the machinery can be prohibitively expensive.

Such conventional methods and systems generally have been considered satisfactory for their intended purposes. However, each has the above-mentioned undesirable aspects. Although the need for solutions to these deficiencies has long been felt, there still remains a continued need in the art for a counting apparatus capable of quickly, accurately, and consistently counting predetermined numbers of test strips without undue damage to the test strips. There also remains a need in the art for such a counting apparatus that is inexpensive and easy to make and use. The present invention provides a solution for these problems.

### SUMMARY OF THE INVENTION

The purpose and advantages of the present invention will be set forth in and apparent from the description that follows, as well as will be learned by practice of the invention. Additional advantages of the invention will be realized and attained by the methods and systems particularly pointed out in the written description and claims hereof, as well as from the appended drawings.

To achieve these and other advantages and in accordance with the purpose of the invention, as embodied herein and broadly described, the invention includes a counting apparatus for providing a predetermined number of diagnostic test strips including a tray having a plurality of elongate indentations defined by a first surface of the tray, wherein each elongate indentation is configured to receive at least one diagnostic test strip. A subset of the elongate indentations includes open indentations that are open at one end proximate a first edge of the tray.

In further accordance with the invention, a funnel may be provided for receiving and directing a predetermined number of diagnostic test strips from the open indentation on the tray.

In accordance with a further aspect of the invention, at least one of the elongate indentations may be a closed indentation that is closed at one end proximate the first edge of the tray. The closed indentation is preferably configured to receive diagnostic test strips in excess of the predetermined quantity.

In accordance with another aspect of the invention, each open indentation is configured to receive one diagnostic test strip. Preferably, the tray includes between about 5 and about 100 open indentations. Preferably, the tray includes about 50 open indentations.

In accordance with another aspect of the invention, a hinge may be provided connecting the tray to the funnel. The hinge is preferably configured to rotate the tray from a first position in which diagnostic test strips are sorted on the tray to a second position in which the predetermined number of diagnostic test strips slide through the funnel and into a container.

In accordance with one embodiment of the invention, the tray and the funnel are a unitary piece. In further accordance with another embodiment of the invention, the funnel and tray of the unitary piece are stationary relative to one another during operation of the counting apparatus.

In accordance with still another aspect of the invention, a container is provided. The container may be adapted to receive the predetermined number of diagnostic test strips from the funnel. If desired, the container may be adapted to receive the predetermined number of diagnostic test strips directly from the tray without a funnel. The container can be a pouch, a vial, a bottle, a jar, a bag, or an envelope, among others.

In accordance with still another aspect of the invention, the counting apparatus may further include a plate for covering a predetermined subset of the one open indentations to prevent diagnostic test strips from falling into the subset of the one open indentations. The plate is preferably adapted to prevent diagnostic test strips from falling into a predetermined subset of between about 10 percent and about 75 percent of the open indentations.

The invention also provides a method for counting a predetermined number of diagnostic test strips. The method includes providing a tray as described herein The method also includes disposing a plurality of diagnostic test strips on the tray, sorting the diagnostic test strips on the tray until a predetermined number of diagnostic test strips have been received by open indentations in the tray, and directing the predetermined number of diagnostic test strips from the tray into a funnel.

In further accordance with the invention, the method may further include directing the diagnostic test strips from the funnel into a container as described herein.

In accordance with still another aspect of the invention, the tray is tilted relative to the funnel to direct the diagnostic test strips into the container.

In accordance with a further aspect of the invention, the predetermined number of diagnostic test strips may be in excess of one.

In accordance with yet another aspect of the invention, the diagnostic test strips may be sorted into indentations in the tray manually. If desired, the diagnostic test strips may be sorted into indentations in the tray automatically.

It is to be understood that both the foregoing general description and the following detailed description are exemplary and are intended to provide further explanation of the invention claimed.

The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF THE DRAWINGS

FIG. 1 is a perspective view of a first representative embodiment of a counting apparatus in accordance with the present invention, showing a tray with elongate open indentations and a funnel.

FIG. 2 is a perspective view of the tray of the counting apparatus shown in FIG. 1, showing a pile of test strips on the tray prior to being sorted into the open indentations.

FIG. 3 is a perspective view of the tray of the counting apparatus shown in FIG. 1, showing the test strips sorted into the open indentations in the middle of the tray and into an overflow indentation on each end of the tray.

FIG. 4 is a perspective view of the counting apparatus shown in FIG. 1, showing the counted test strips being cleared out of the open indentations and directed through the funnel into a container.

FIG. 5 is a side view of the counting apparatus shown in FIG. 1, showing a base and a hinge connecting the tray to the base and funnel. The arrow indicates how the tray rotates to clear the counted test strips into the funnel and ultimately into the container.

FIG. 6 is a perspective view of the tray of the counting apparatus shown in FIG. 1, showing a reducer plate covering a subset of the open indentations to reduce the number of counted test strips in each batch.

FIG. 7 is a perspective view of another representative embodiment of a counting apparatus in accordance with the present invention, showing a tray for counting test strips and a container for receiving counted test strips without a funnel.

### DETAILED DESCRIPTION OF THE PREFERRED EMBODIMENT

Reference will now be made in detail to the present preferred embodiments of the invention, an example of which is illustrated in the accompanying drawings. The method and corresponding steps of the invention will be described in conjunction with the detailed description of the system.

The devices and methods presented herein may be used for counting diagnostic test strips. The present invention is particularly suited for accurate, efficient counting of predetermined quantities of diagnostic test strips, such as when counting quantities of test strips for packaging purposes.

In accordance with the invention, a counting apparatus is provided including a tray including a plurality of elongate indentations defined by a first surface of the tray, each elongate indentation being configured to receive at least one diagnostic test strip, wherein a subset of the elongate indentations includes open indentations that are open at one end proximate a first edge of the tray, and a funnel for receiving and directing a predetermined number of diagnostic test strips from the open indentations on the tray.

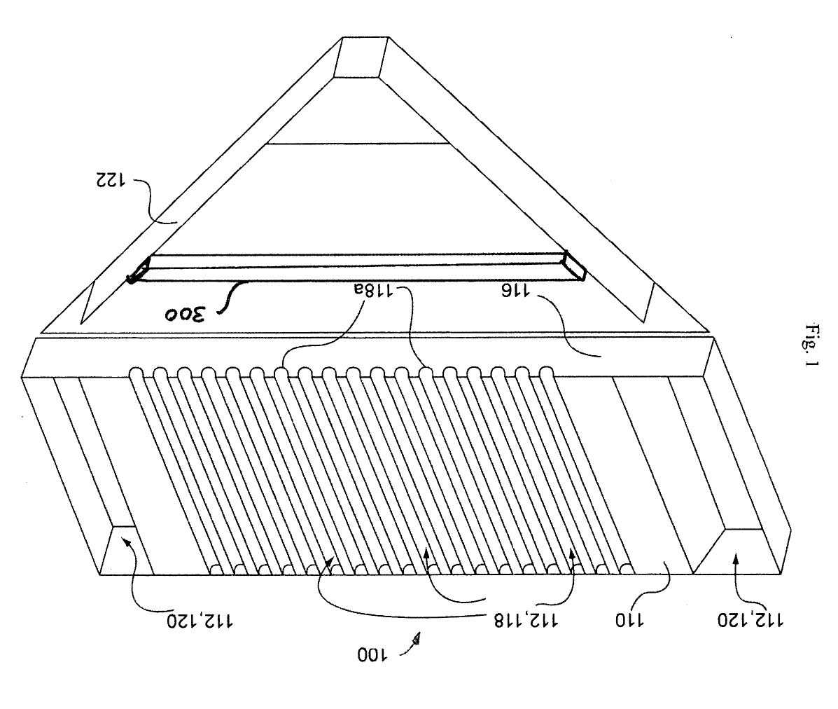

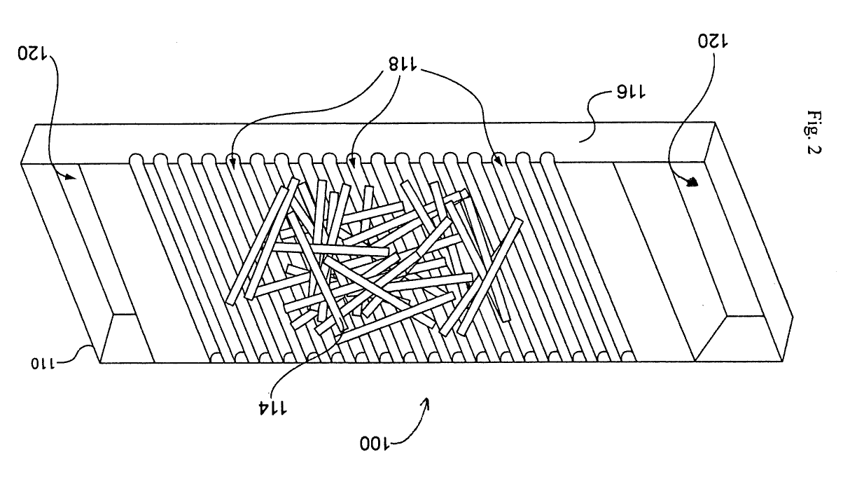

For purposes of explanation and illustration, and not limitation, a partial view of an exemplary embodiment of the counting apparatus in accordance with the invention is shown in FIG. 1 and is designated generally by reference numeral 100. Other embodiments of a counting apparatus 100 in accordance with the invention, or aspects thereof, are provided in FIGS. 2-7, as will be described.

In accordance with the invention, and as depicted in FIGS. 1 and 2, a tray 110 is provided including a plurality of elongate indentations 112 on the upper surface of the tray 110. An uncounted amount of test strips 114 can be deposited onto the plurality of elongate indentations 112 of the tray 110 for counting. A predetermined number of the elongate indentations 112 is open along one end 118a proximate to a first edge 116 of the tray 110, making a predetermined number of open indentations 118. Preferably, the predetermined number of open indentations 118 is between about 5 and 100 indentations. More preferably, the predetermined number of open indentations is about 50.

In further accordance with the invention, each open indentation 118 is preferably dimensioned to accommodate a single test strip 114. However, those skilled in the art will readily appreciate that in alternative embodiments the open indentations 118 can also each be dimensioned to accommodate a plurality of test strips. For example, the open indentations 118 could be dimensioned to accommodate two or more test strips each without significantly affecting the precision of the counting apparatus 100. Counting errors will occur with increasing frequency as the number test strips 114 accommodated in each open indentation 118 increases, due to cumulative errors arising from variation in the size of the test strips 114. As long as the number of test strips 114 fitting in each open indentation 118 is known within an acceptable margin of error, those of ordinary skill in the art will readily be able to make and use these alternative embodiments without departing from the scope and spirit of the invention. The counting apparatus 100 thus provides a predetermined number of test strips using a predetermined number of open indentations 118, but the two predetermined numbers are not necessarily the same.

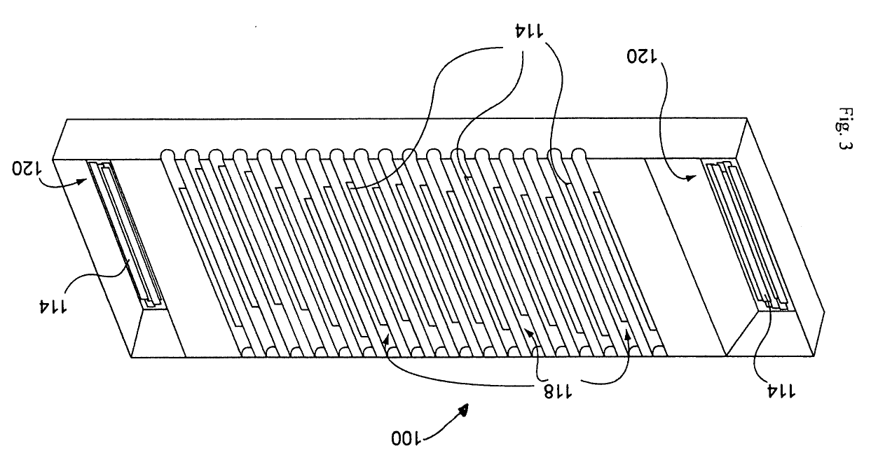

With an uncounted quantity of test strips 114 deposited on the tray 110, the test strips 114 can be manipulated until each open indentation 118 is filled with a single test strip 114, or known number of test strips 114, as depicted in FIG. 3. Since the number of open indentations 118 is predetermined, and since each open indentation 118 may contain a single test strip 114, the number of test strips 114 contained in the open indentations 118 is equal to the predetermined number (or a known multiple thereof).

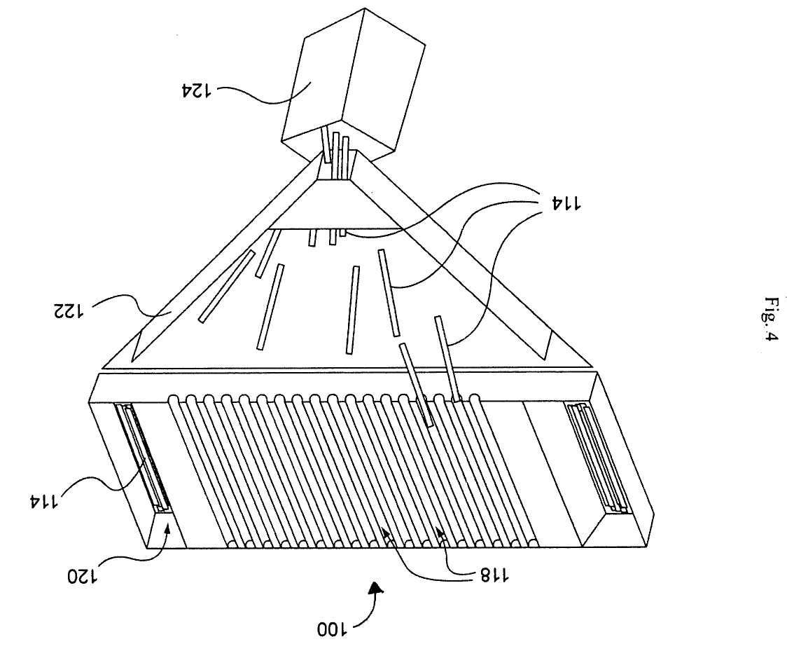

In further accordance with the invention, and as depicted in FIG. 4, a funnel 122 is provided for collecting and directing the counted test strips 114 from the plurality of open indentations 118. When all of the open indentations 118 are filled with counted test strips 114, and when any remaining uncounted test strips 114 have been swept aside into overflow indentations 120, described in detail below, the open indentations 118 can be cleared, sliding the counted test strips 114 out of the open indentations 118 along the edge 116 of the tray 110 and into the funnel 122. Clearing the open indentations 118 is preferably accomplished simply by tipping the tray 110 to allow the counted test strips 114 to freely slide off the edge 116. Other methods of clearing the open indentations include pushing or pulling the counted test strips 114 off the edge 116 by hand or with a pusher or other tool configured to engage the elongate indentations 112 as is known in the art.

In further accord with the invention, the counted test strips 114, after being cleared from the open indentations 118, can slide through the funnel 122, which conducts them into the opening of a container 124. The end result is that container 124 contains a predetermined number of counted test strips 114. In the alternative, container 124 may contain multiple batches of counted test strips 114, each batch containing the predetermined number of counted test strips 114, or a known multiple thereof.

There are a variety of different possible types of container 124. For purposes of illustration and not limitation, the container 124 can be a pouch, envelope, bag, jar, bottle, box or a vial.

In accordance with another aspect of the invention, and as depicted in FIGS. 3 and 4, at least one overflow indentation 120 may be provided that is not open along the edge 116 of the tray 110. Preferably, an overflow indentation 120 is provided on each end of the tray 110, with a plurality of open indentations 118 in the middle of the tray 110 disposed between the two overflow indentations 120. Once the open indentations 118 are each filled with one or more test strips 114, any remaining uncounted test strips 114 from the original pile can be swept aside into the overflow indentations 120, as depicted. It will be recognized by those of ordinary skill in the art, however, that the invention can be practiced without overflow indentations 120 by simply sweeping uncounted test strips 114 off the tray 110.

In a preferred embodiment, when all of the uncounted test strips 114 have been swept into the overflow indentations 120, leaving only the counted test strips 114 in the open indentations 118, the tray 110 can be tipped toward the container 124. The uncounted test strips 114 that were swept into the overflow indentations 120 remain in the overflow indentations 120 when the tray 110 tips because the ends of the overflow indentations 120 are not open along the edge 116 of the tray 110. It will be readily appreciated by those of ordinary skill in the art that the overflow indentations 120 can also function to prevent uncounted test strips 114 from mixing with counted test strips 114 if methods other than tipping are used to clear the open indentations 118. After the tray 110 is cleared, and if necessary tipped back to its original position, the uncounted test strips 114 can then be removed from the tray 110, or they can be further piled and sorted on tray 110 with or without the addition of other further test strips 114, and the entire process can be repeated.

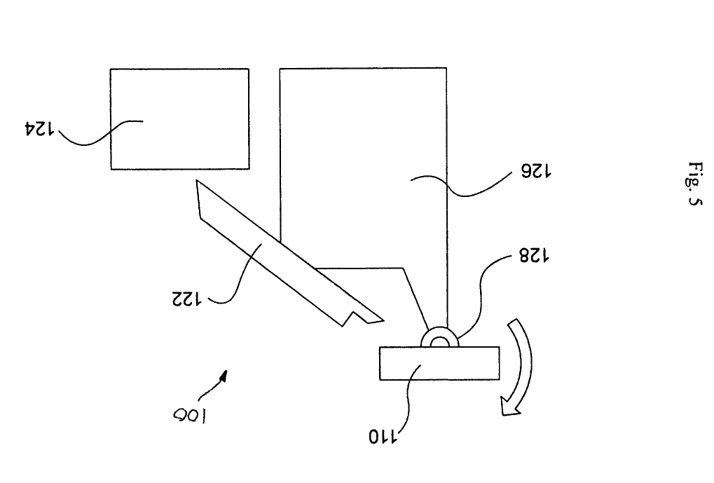

In further accordance with the invention, and as depicted in FIG. 5, the counting apparatus 100 can further include a base 126 with a hinge 128 connecting the tray 110 to the funnel 122. Preferably, the hinge 128 and base 126 are configured to allow the tray 110 to rotate from a first position in which the test strips 114 are piled and sorted, to a second position in which the counted test strips 114 slide into the funnel 122, which remains unmoved. One advantage of this embodiment is that it allows successive containers 124 to be set in the same position under the small opening of the funnel 122, streamlining the counting process. However, one of ordinary skill in the art will readily appreciate how to practice the invention with the tray 110 and funnel 122 being a unitary piece with no hinge 128 or base 126 without departing from the spirit and scope of the invention. For example the funnel 122 and tray 110 may be a unitary piece. Once the counted test strips 114 are disposed in open indentations 118, the entire unitary piece can be tipped so the funnel 122 portion is downward. This can allow the counted test strips 114 to slide out of the open indentations 118 and into the funnel 122.

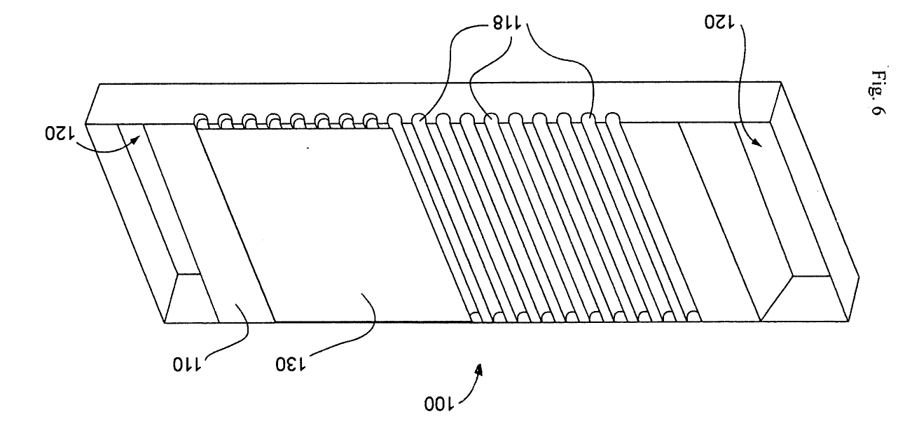

By way of further example, for purposes of illustration only, the counting apparatus 100 can be further provided with a removable reducer plate 130, as shown in FIG. 6. It may be desirable from time to time to change the number of counted test strips 114 counted by the counting apparatus 100. For this purpose, reducer plate 130 may be dimensioned to cover a subset of the open indentations 118 when engaged with the tray 110. The reducer plate 130 covers the subset of the open indentations 118 and thus prevents test strips 114 from falling into that subset of open indentations 118. The reducer plate 130 covers a known number of the open indentations 118, and thereby reduces the number of available open indentations 118 by that number. The number of remaining available open indentations 118 is thus known, and the counting apparatus 100 can be used according to the manner described above only with reduced numbers of counted test strips 114 in each batch. Preferably, the reducer plate 130 reduces the number of available open indentations 118 by about 10 percent to about 75 percent, depending on the various packaging needs of the test strip supplier.

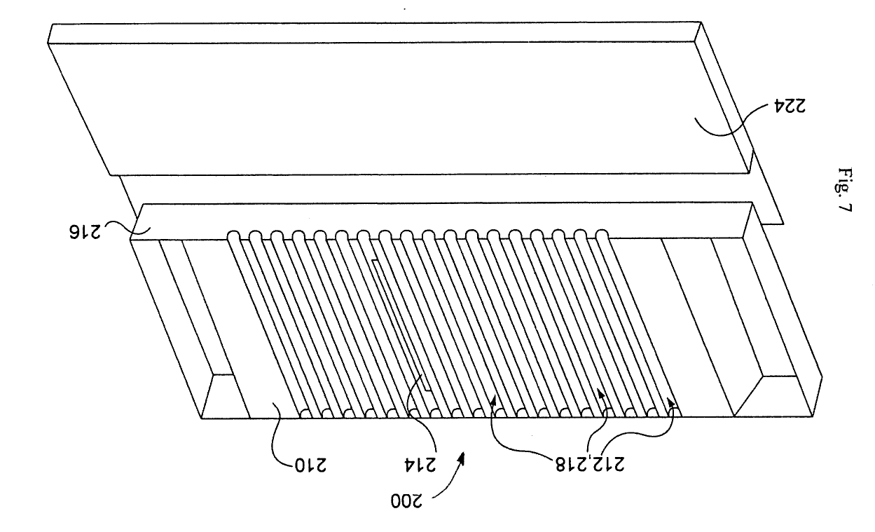

For purposes of explanation and illustration, and not limitation, a partial view of another exemplary embodiment of the counting apparatus in accordance with the invention is shown in FIG. 7 and is designated generally by reference character 200.

In accordance with the invention, a tray 210 includes a plurality of elongate indentations 212 defined on the top surface of the tray 210. Each elongate indentation 212 is configured to receive at least one test strip 214. At least one of the elongate indentations 212 is open on one end proximate to an edge 216 of the tray 210, making at least one open indentation 218, as described above.

In further accordance with the invention, a container is provided. As depicted in FIG. 7, the container 224 is adapted to receive a predetermined quantity of test strips 214 from the tray 210. This embodiment differs from embodiments described above in that there is no funnel 122, rather the container 224 can receive counted test strips 214 directly from the tray 210.

In further accordance with the invention, the surfaces of the devices disclosed herein (100, 200) can be treated with an anti-static agent to prevent static forces from influencing the movement of the test strips (114, 214). Suitable anti-static agents can include, for example, commercially available sprays containing quaternary ammonium compounds such as PolyOxyPropylene Methyl Diethyl Ammonium Chloride. These types of materials can be purchased from office equipment or engineering supply companies and are packaged in a propellant driven aerosol can, manual pump dispensers, or embedded in a fabric for application by wiping. Simple formulations can also be made by diluting fabric softener and ammonia in water. An example of a commercially available material is Dust Guardian® Anti-Static Spray. Anti-Static Office Cleaner Towel Products from Interstate Products Inc (Sarasota, Fla.) is a source of materials that can be used to treat equipment by wiping. It will be appreciated by those of skill in the art that an antistatic agent as described herein may be supplied alone, or in a kit in combination with a device made in accordance with the present invention.

By way of further example, a static reducing bar can alternatively be supplied to control static electricity built up on the surfaces of devices 100, 200. For example, as depicted in FIG. 1, a static reducing bar 300 may be mounted pm funnel portion 122 of device 100. Static reducing bar can similarly be suspended proximate the edge 116, 216 of trays 110, 210. Suitable static reduction bars are available, for example, from Simco Company, U.S.A. (2257 North Penn Road, 19440 Hatfield, Pa.) (found on the internet at: http://www.simco.nl/products/static-elimination/anti-static-bars/).

In accordance with another aspect of the invention, a method for counting a predetermined number of diagnostic test strips is provided. The method includes the step of providing a tray including a plurality of elongate indentations as described herein, for example. The method further includes disposing a plurality of diagnostic test strips on the tray, sorting the diagnostic test strips on the tray until a predetermined number of diagnostic test strips have been received by open indentations in the tray, and directing the predetermined number of diagnostic test strips into a funnel. For purposes of illustration and not limitation, as embodied herein the method can be carried out using the device as described herein.

As alluded to above, the method also includes the step of sorting the test strips (e.g., 114) on the tray (e.g., 110) until a predetermined number of test strips (e.g., 114), preferably more than one, has been received by at least one open indentation (e.g., 118). Use of sweeping motions across the unsorted test strips 114 is an efficient way of performing the sorting step. For example, a person's hand, a manual tool, or an automatic tool can perform the sweeping motions. Other ways of sorting the test strips into the open indentations 118, such as by way of example and not limitation, vibrating the tray 110, or combinations of sweeping and vibrating, whether manual or automated, are not beyond the scope and spirit of the invention.

Preferably, in order to avoid losses of test strips 114 and inaccurate counting, the sorting is performed without significantly overflowing the tray 110, which could lead to losses and inaccurate counting. The sorting process continues until each open indentation 118 is filled, adding further test strips 114 if necessary to fill each available open indentation 118, and until excess test strips are swept aside. Since at this point the number of test strips 114 in the open indentations 118 is known, as described above, the test strips 114 in the open indentations 118 are now counted test strips 114.

As further described above, the method also includes the step of directing the predetermined number of now counted test strips e.g., 114 into a funnel e.g., 122. Directing the counted test strips 114 into the funnel 122 involves clearing the open indentations 118. As mentioned above, this is preferably accomplished by simply tipping the tray 110 to allow the counted test strips 114 to freely slide off the edge 116. If the funnel 122 and tray 110 are unitary, they can be tipped together to clear the counted test strips 114 into the funnel. It will be recognized that other methods of clearing the open indentations may be employed, including pushing or pulling the counted test strips 114 off the edge 116 by hand or with a pusher or other tool configured to engage the elongate indentations 112 as is known in the art. Regardless of how the counted test strips 114 clear the open indentations 118, the counted test strips 114 move into the funnel 122 as they are cleared.

The step of directing the test strips from the funnel into a container may use any suitable container, as described herein.

The methods and systems of the present invention, as described above and shown in the drawings, provide for a counting apparatus with superior properties including being capable of quickly, accurately, and consistently counting predetermined numbers of test strips without undue damage to the test strips, as well as being inexpensive and easy to make and use. It will be apparent to those skilled in the art that various modifications, variations, and combinations can be made in the device and method of the present invention without departing from the spirit and scope of the invention. Thus, it is intended that the present invention include modifications, variations, and combinations that are within the scope of the appended claims and their equivalents.

What is claimed is:

1. A counting apparatus for providing a predetermined number of diagnostic test strips comprising:
a) a tray including a plurality of elongate indentations defined by a first surface of the tray, each elongate indentation being configured to receive at least one diagnostic test strip, wherein a subset of the elongate indentations includes open indentations that are open at one end proximate a first edge of the tray; and
b) a funnel for receiving and directing a predetermined number of diagnostic test strips from the open indentations on the tray.

2. The counting apparatus of claim 1, wherein at least one of the elongate indentations is a closed indentation that is closed at one end proximate the first edge of the tray, the closed indentation being configured to receive diagnostic test strips in excess of the predetermined number.

3. The counting apparatus of claim 1, further comprising a hinge connecting the tray to the funnel, the hinge being configured to rotate the tray from a first position in which diagnostic test strips are sorted on the tray to a second position in which the predetermined number of diagnostic test strips slide through the funnel and into a container.

4. The counting apparatus of claim 1, further comprising a container adapted to receive the predetermined number of diagnostic test strips from the funnel.

5. The counting apparatus of claim 4, wherein the container is selected from the group consisting of a pouch, a vial, a bottle, a jar, a bag, and an envelope.

6. The counting apparatus of claim 1, wherein the tray and the funnel are a unitary piece.

7. The counting apparatus of claim 6, wherein the tray and funnel of the unitary piece are stationary relative to one another during operation of the counting apparatus.

8. The counting apparatus of claim 1, wherein each open indentation is configured to receive one diagnostic test strip.

9. The counting apparatus of claim 1, wherein the tray includes between about 5 and about 100 open indentations.

10. The counting apparatus of claim 9, wherein the tray includes about 50 open indentations.

11. The counting apparatus of claim 1, further comprising a plate for covering a predetermined subset of the open indentations to prevent diagnostic test strips from falling into the subset of the open indentations.

12. The counting apparatus of claim 11, wherein the plate is adapted to prevent diagnostic test strips from falling into a predetermined subset of between about 10 percent and about 75 percent of the open indentations.

13. A method of counting a predetermined number of diagnostic test strips comprising:
a) providing a tray including a plurality of elongate indentations defined by a first surface of the tray, wherein a subset of the elongate indentations includes open indentations that are open at one end proximate a first edge of the tray, each open indentation being configured to receive at least one diagnostic test strip;
b) disposing a plurality of diagnostic test strips on the tray;
c) sorting the diagnostic test strips on the tray until a predetermined number of diagnostic test strips have been received by the open indentations, adding further diagnostic test strips as needed to reach the predetermined number; and
d) directing the predetermined number of diagnostic test strips into a funnel.

14. The method of claim 13, wherein the predetermined number of diagnostic test strips is in excess of one.

15. The method of claim 14, further comprising directing the diagnostic test strips from the funnel into a container.

16. The method of claim 15, wherein the diagnostic test strips are directed out of the tray and into the container by tilting the tray.

17. The method of claim 16, wherein the tray is tilted relative to the funnel to direct the diagnostic test strips into the container.

18. The method of claim 14, wherein the diagnostic test strips are sorted into indentations in the tray manually.

19. The method of claim 14, wherein the diagnostic test strips are sorted into indentations in the tray automatically.

20. The method of claim 14, further comprising covering a predetermined subset of the open indentations with a plate to prevent diagnostic test strips from falling into the subset of open indentations.

21. A counting apparatus for providing a predetermined number of diagnostic test strips comprising:
a) a tray including a plurality of elongate indentations defined by a first surface of the tray, each elongate indentation being configured to receive at least one diagnostic test strip, wherein at least one of the elongate indentations is an open indentation that is open at one end proximate an edge of the tray; and
b) a container removably associated with the tray, wherein the container is adapted to receive a predetermined number of diagnostic test strips from the tray.
